(19) United States
(12) Patent Application Publication
(10) Pub. No.: US 2007/0177595 A1
(43) Pub. Date: Aug. 2, 2007

(54) DTV decoding system and de-multiplexing method thereof

(75) Inventors: You-Min Yeh, Keelung City (TW); Chien-Chung Chen, Sanchong City (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(73) Assignee: Mediatek Inc.

(21) Appl. No.: 11/342,914

(22) Filed: Jan. 30, 2006

(51) Int. Cl. H04L 12/56

(52) U.S. Cl. 370/392; 370/401

(57) ABSTRACT

A header information parsing and extracting method for a DTV decoding system is provided. A transport stream comprising a plurality of PES packets is received. At least one field of PES headers or headers within ES is selectively extracted from the transport stream to a programmable table. The access units are extracted from the PES packets to an elementary stream buffer. The fields in the programmable table are read to control an elementary stream decoding. The access units in the elementary stream buffer are read for the elementary stream decoding. The field to extract is selected by control signals, and the programmable table is accordingly established when the field is selected.

### BACKGROUND OF THE INVENTION

1. Field of the Invention

The invention relates to digital television (DTV), and in particular, to a DTV receiver de-multiplexing a transport stream flexibly.

2. Description of the Related Art

FIG. 1 shows a conventional packet structure according to ISO/IEC 13818-1 standard. ISO/IEC 13818-1 is a standard defining a packetized transmission scheme for MPEG data streams and it could be utilized in DTV systems. RF signals are received and demodulated to a digital bit stream referred to as a transport stream (TS). A transport stream 110 may comprise one or more programs. The transport stream 110 is segmented per 188 bytes, and each segment comprises a TS header 102 and a TS payload 104. Through filtering and de-multiplexing, a plurality of TS payloads 104 of a specific program may be extracted from the transport stream 110 to form a stream of Packetized Elementary Stream (PES) packets 120 comprising a PES header 106 and a PES payload 108. The PES header 106 comprises various fields defining parameters associated with the PES payload 108, such as presentation time stamp (PTS), decoding time stamp (DTS) and so on. The plurality of PES payloads 108 may further be reorganized to form an elementary stream (ES) of the MPEG standard, such as the access unit 130 in FIG. 1, comprising a header within ES 112 and a compressed data of ES 114. The compressed data of ES 114 may be audio or video data, and the header within ES 112 are parameters required to decode the compressed data of ES 114, such as picture types or start codes. An ES decoding scheme may further be provided to decode the access unit 130 based on the information recorded in the PES headers 106 and headers within ES 112.

FIG. 2a and 2b show block diagrams of conventional method to extract and parse information of PES headers and headers within ES (such as sequence headers, group-of-picture (GOP) headers, picture headers). The decoding system 200 in FIG. 2a comprises a de-multiplexer 210, a memory 220, a PES parser 230, a system controller 240 and a decoder 250. The de-multiplexer 210 receives a transport stream and extracts PES packets 120 therefrom to a PES buffer 202 in the memory 220. The PES parser 230 then reads the PES buffer 202 to parse the PES packets 120, obtaining PES headers 106 and PES payloads 108 that are then stored in a header buffer 204 and a elementary stream buffer 206 respectively. Thus, the header buffer 204 stores a plurality of PES headers 106, and the elementary stream buffer 206 stores a plurality of PES payloads 108. The PES payloads 108 may be reorganized to form an elementary stream comprising a plurality of access units 130, and the elementary stream buffer 206 stores the access units 130. Thereafter, the system controller 240 reads the PES headers 106 from the header buffer 204 and the headers within ES 112 from the ES buffer 206 to perform a post-parsing, and the decoder 250 reads the compressed data of ES 114 from the elementary stream buffer 206 to perform the elementary stream decoding under control of the system controller 240.

In FIG. 2b, an improved decoding system 201 is provided. The PES parser 230 in FIG. 2a is substituted by a PES parser 235 implemented in the de-multiplexer 210. The de-multiplexer 210 receives the transport stream, extracts the PES packets 120, and the PES parser 235 parses the PES packets 120 simultaneously in real time. Thus, redundant memory access between the PES buffer 202 and the PES parser 230 in FIG. 2a is not required, and system efficiency is improved. In the conventional decoding system 200 and 201, after the system controller 240 reads the PES headers 106 from the header buffer 204 and the headers within ES 112 from the ES buffer 206, a post-parsing is performed to parse essential information then written back to a plurality of field buffers 208 in the memory 220, such that elementary stream decoding can be performed.

FIG. 3 is a flowchart of a conventional method to extract and parse information of PES headers and headers with ES according to FIG. 2b. In step 302, a transport stream is received. In step 304, the transport stream is de-multiplexed to obtain a plurality of PES packets 120 corresponding to a specific program. In step 306, parse the PES packets 120 and store the PES packet headers 106 in a header buffer and the PES packet payloads 108 in a ES buffer. The associating access units 130 parsed from the PES payloads 108 are stored in an elementary stream buffer 206. In step 308, the system controller 240 reads and post-parses the PES headers 106 from the header buffer 204 and the headers within ES 112 from the ES buffer 206 for control of a post-parsing process, while the decoder 250 reads the compressed data of ES 114 from the elementary stream buffer 206 to perform the elementary stream decoding controlled by the system controller 240. In step 310 after the system controller 240 post-parses the PES headers 106 and headers within ES 112, some specific chosen information of the PES headers 106 or headers within ES 112 is further written back to at least one field buffer 208 in the memory 220 as an essential basis to appropriately decode the access units 130.

For PES packets 120, the PES headers 106 occupy a significant portion, thus accessing the header buffer 204 in the memory 220 induces unavoidable overheads. The computation cost for parsing the PES headers 106 is also burdensome. Therefore improvement is desirable.

### BRIEF SUMMARY OF INVENTION

A detailed description is given in the following embodiments with reference to the accompanying drawings.

An exemplary DTV decoding system is provided for de-multiplexing a transport stream comprising a plurality of packetized elementary stream (PES) packets. Each PES packet comprises a header and a payload, and the header comprises a plurality of fields recording various information associated with the payload. Elementary stream could be composed from PES packet payload, and the headers within ES, such as sequence headers, group-of-picture headers and picture-headers, comprise a plurality of fields recording various information associated with the corresponding unit. The DTV decoding system comprises a de-multiplexer, a memory, a system controller, and a decoder. The de-multiplexer receives the transport stream and decodes the PES packets therein, and selectively extracts fields of PES packet header and headers within ES based on a set of control signals. The memory coupled to the de-multiplexer comprises a plurality of programmable tables each storing a specific field of PES headers or headers within ES, and an elementary stream buffer storing access units composed from the PES packet payloads. The system controller coupled to the memory reads the fields in the programmable tables to control elementary stream decoding. The decoder coupled to the memory reads the access units in the elementary stream buffer to perform the elementary stream decoding. Each of the control signals delivers a request for a selected field, and a programmable table is accordingly established upon receipt of the control signal and the de-multiplexer extracts the selected field thereto.

The de-multiplexer comprises a register controller and a PES/ES parser. The register controller performs field selection and programmable table management based on the set of control signals. The PES/ES parser decodes the PES packets and ES, and synchronously extracts the access units and the selected fields to the elementary stream buffer and the programmable tables.

The register controller comprises a plurality of register sets configuring corresponding programmable tables based on the control signals, and each register set comprises a start address register allocating the starting address of the corresponding programmable table, and a buffer type register, defining the field the corresponding programmable table represents.

The register set further comprises a buffer valid register, defining whether the current register set is enabled to establish a programmable table in the memory.

Each programmable table comprises a plurality of rows each comprising a data column storing information of a selected field extracted from the PES/ES parser, and a tag column storing an unique TAG associated with each access unit. Optionally, each register set further comprises a word length register defining the row size, and a data length register, defining the data column size.

The memory may be a dynamic random access memory (DRAM). The system controller may be a regular instruction set computer (RUSC) processor. The decoder may be an alternative of a video decoder and an audio decoder. The control signals are delivered by the system controller.

Another embodiment of the invention provides a de-multiplexing method for a DTV decoding system. A transport stream comprising a plurality of PES packets is received. At least one field of the PES headers or headers within ES is selectively extracted from the transport stream to a programmable table. The access units are extracted from the PES packets to an elementary stream buffer. The fields in the programmable table are read to control an elementary stream decoding. The access units in the elementary stream buffer are read for the elementary stream decoding. The field to be extracted is selected by a control signal, and the programmable table is accordingly established when the field is selected.

### BRIEF DESCRIPTION OF DRAWINGS

The following detailed description, given by way of example and not intended to limit the invention solely to the embodiments described herein, will best be understood in conjunction with the accompanying drawings, in which:

FIG. 1 shows a conventional packet structure according to ISO/IEC 13818-1 standard;

FIG. 2a and 2b show block diagrams of conventional methods to extract and parse information of PES headers and headers within ES;

FIG. 3 is a flowchart of a conventional method to extract and parse information of PES headers and headers within ES;

FIG. 4 shows an embodiment of the header extracting and parsing system according to the invention;

FIG. 5 shows an embodiment of the register controller 430 comprising a plurality of register sets 510;

FIG. 6 shows an embodiment of the programmable table 402 established by one of the register sets 510; and

FIG. 7 is a flowchart of the method to extract and parse information of PES headers and ES headers according to the invention.

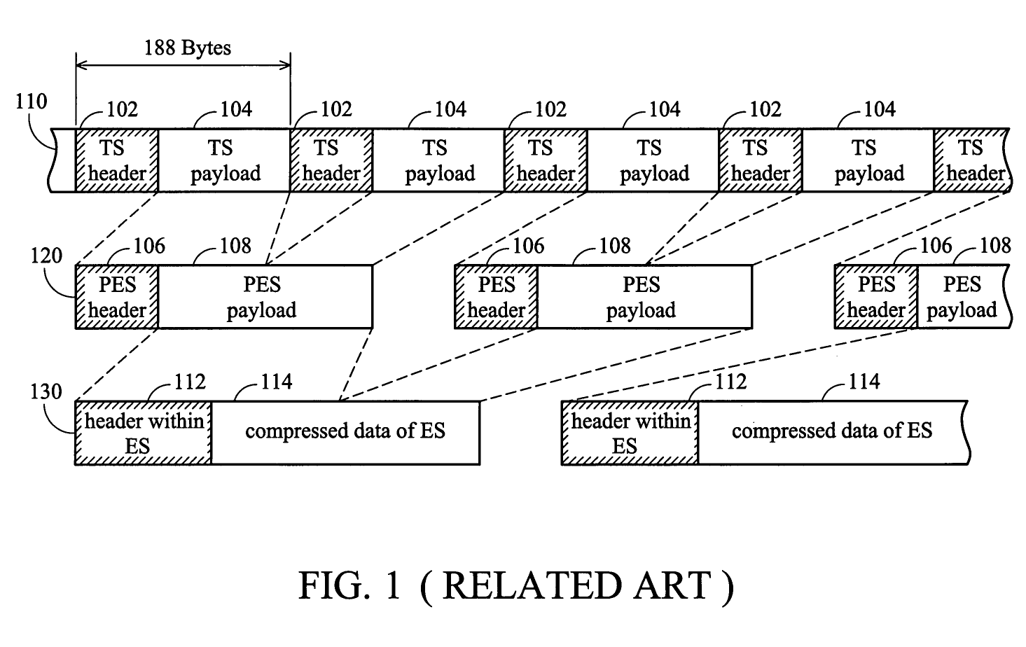

### DETAILED DESCRIPTION OF INVENTION

The following description is of the best-contemplated mode of carrying out the invention. This description is made for the purpose of illustrating the general principles of the invention and should not be taken in a limiting sense. The scope of the invention is best determined by reference to the appended claims.

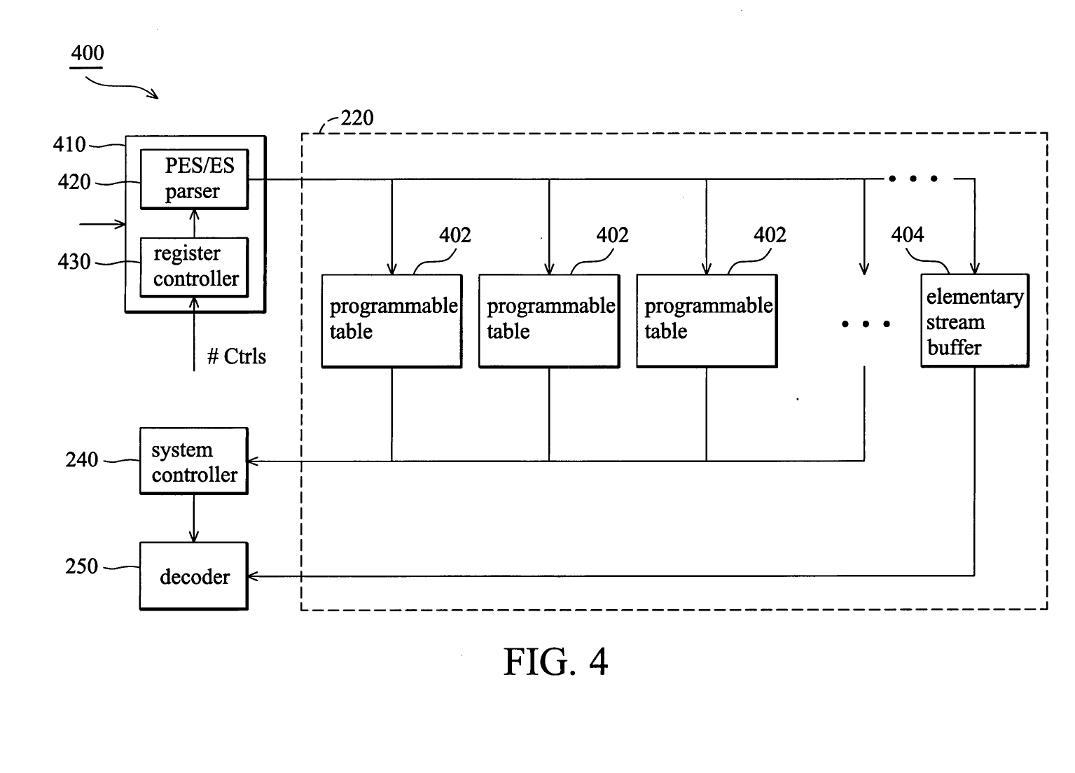

FIG. 4 shows an embodiment of the header extracting and parsing system according to the invention. The decoding system 400 comprises a de-multiplexer 410 processing the incoming transport stream and extracting essential field information into the memory 220. The essential field information required for system controller 240 may be previously defined by control signals #ctrls. For example, the de-multiplexer 410 can extract at least one selected field of PES headers 106 based on the control signal #ctrl delivered thereto. Thus, the de-multiplexer 410 is not required to store the total header information into the memory 220, and the system controller 240 is not required to perform a post-parsing. Instead, the system controller 240 reads the required field information directly from the memory 220 previously generated.

A transport stream comprises one or more programs. The de-multiplexer 410 de-multiplexes the transport stream, obtaining a plurality of PES packets 120 and access units 130 associated with one of the programs. The de-multiplexer 410 comprises a PES/ES parser 420 parsing the PES packets 120 and access units 130, extracting the PES headers 106, PES payloads 108, headers within ES 112, and compressed data within ES 114 therefrom. Additionally, the de-multiplexer 410 comprises a register controller 430 for management of a plurality of programmable tables 402 in the memory 220, and one or more fields parsed from the PES headers 106 and headers within ES 112 are individually stored in corresponding programmable tables 402. The access units 130 are reorganized from the PES payloads 108 simultaneously by the de-multiplexer 410, and stored in an elementary stream buffer 404 in the memory 220. The decoder 250 may be a video decoder or an audio decoder, controlled by the system controller 240 to read and decode appropriate information from the elementary stream buffer 404.

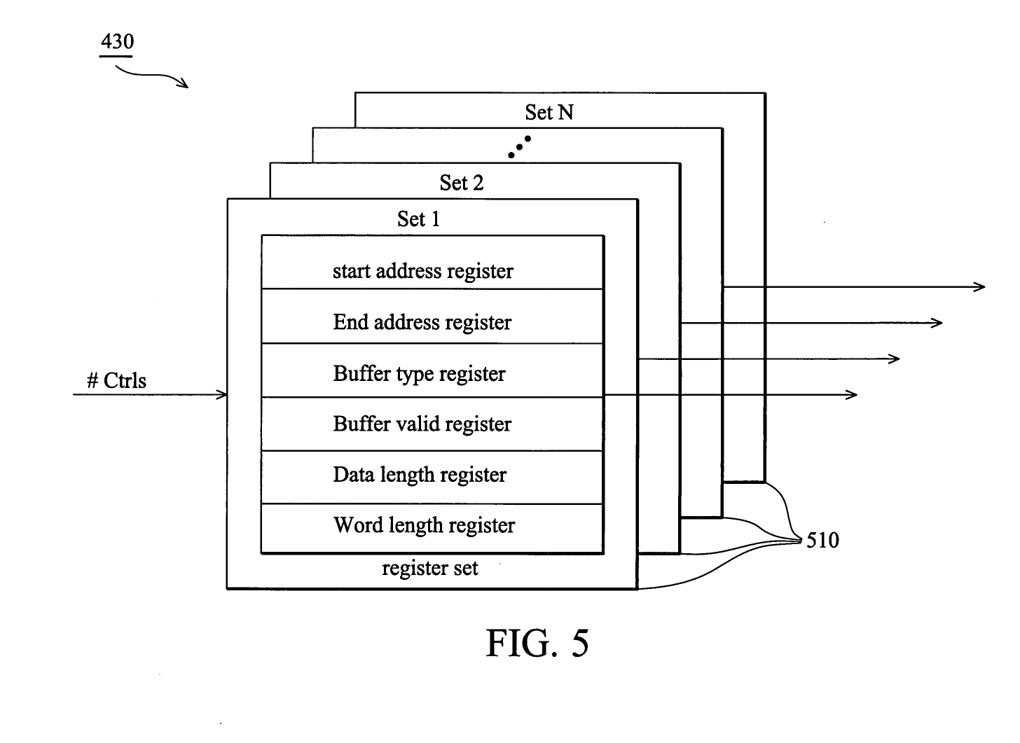

FIG. 5 shows an embodiment of the register controller 430 comprising a plurality of register sets 510. The register controller 430 is a programmable unit contributing management of the programmable tables 402. The system controller 240 requires specific field information for MPEG decoding process, so control signals #ctrls are delivered to the register controller 430 to enable the corresponding field extraction. In this way, only selected fields are parsed and/or extracted, whereas conventional method extracts total headers into the memory 220. Thus the total overheads are significantly reduced, improving efficiency. As an example, each of the register sets 510 may comprise several registers configuring various parameters of a corresponding programmable table 402, as follows.

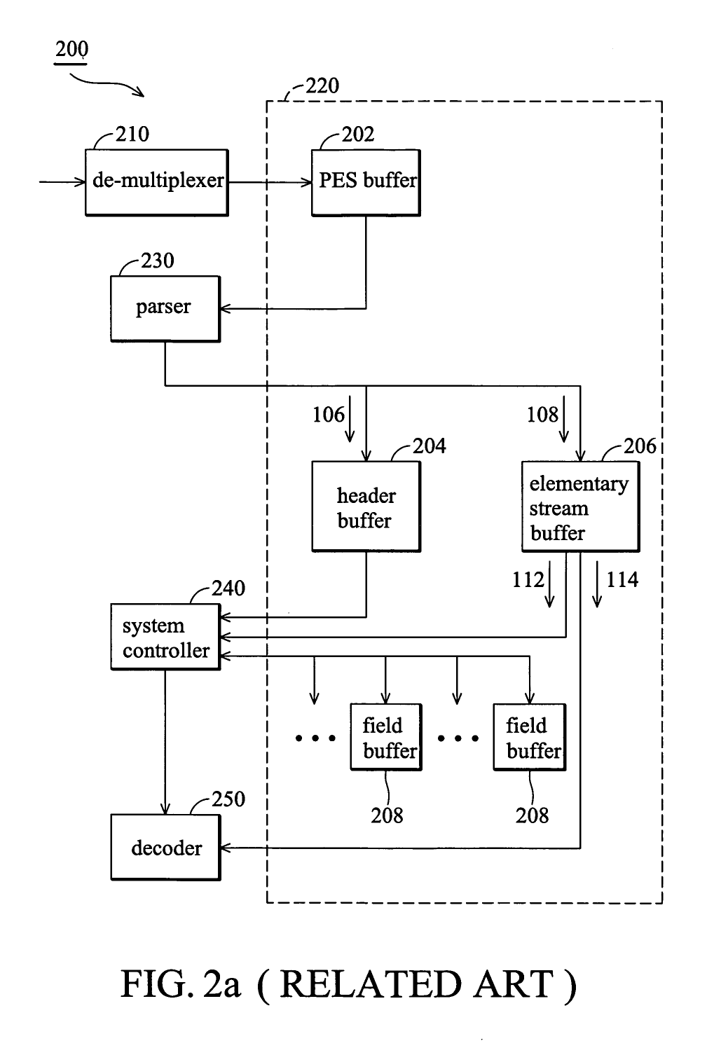

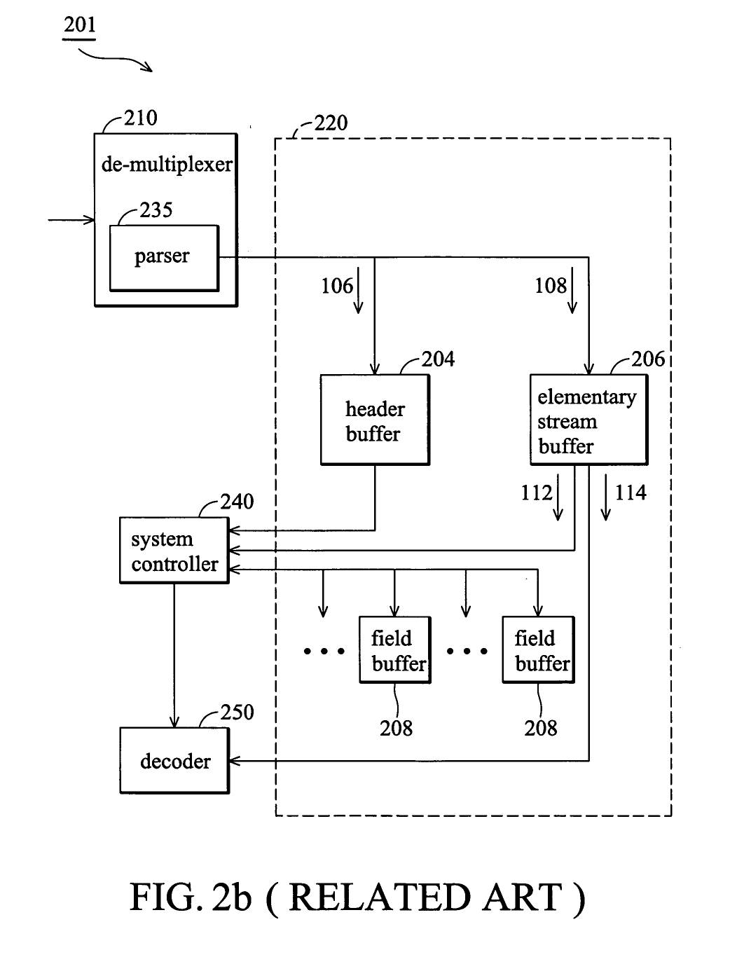

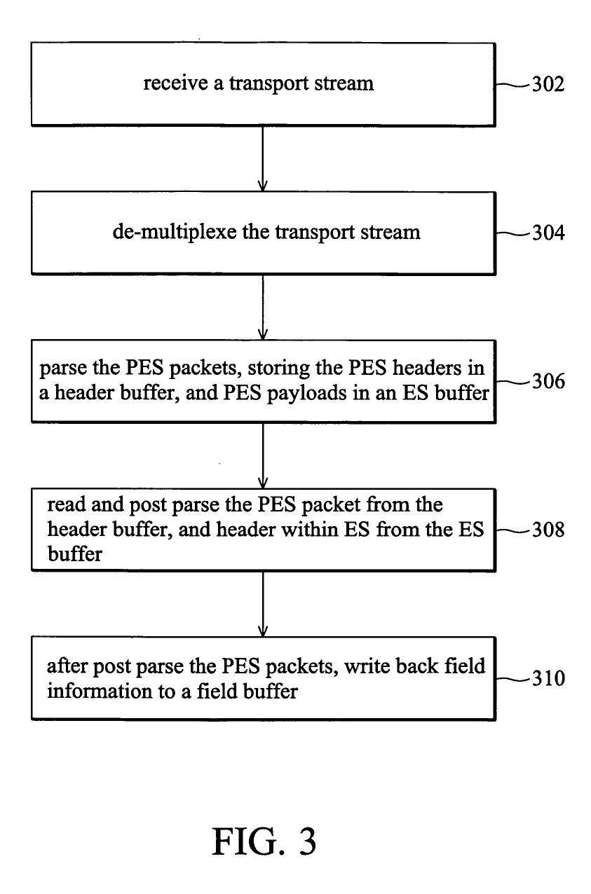

A start address register allocates the starting address of the corresponding programmable table 402. An end address register indicates the ending address of the programmable table 402, being an optional parameter used only for a circular buffer. The buffer length may be a predefined value, such that the end address can be derived from the starting address and the buffer length. A buffer type register defines which field of PES headers or headers within ES the programmable table 402 represents. The ISO/IEC 13818-1 standard specifies detailed syntaxes of the PES header 106 and ISO/IEC 13818-2 standard specifies detailed syntaxes of the elementary stream and headers 112 within, in which various fields are defined, and when a specific field is requested by the system controller 240, the buffer type register is accordingly set to enable the data extraction. In addition to representing a specific field, the buffer type register can represent the total fields in a header, thus the programmable table 402 acts as a conventional field buffer 208 as shown in FIG. 2a and 2b. The buffer type register can also represent a start code indicator in the headers within ES 112, thus the programmable table 402 stores MPEG control codes such as “sequence start”, “GOP start”, “picture start” or “sequence end”. Additionally, the buffer type register can represent a picture type in the picture header within ES 112, thus the programmable table 402 stores picture types of “I-picture”, “P-picture” or “B-picture” for the extracted access unit 130.

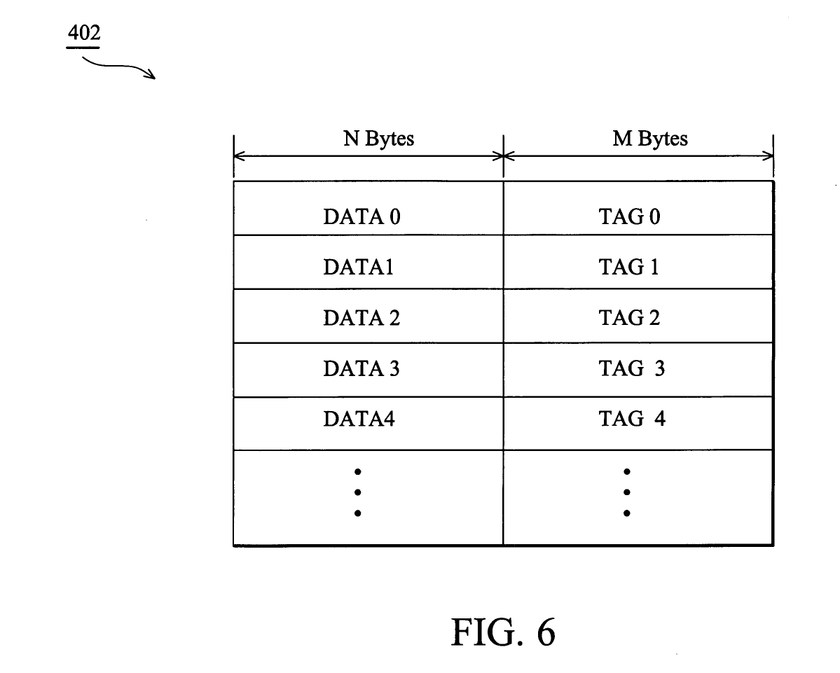

A buffer valid register defines whether the current register set 510 is enabled. The de-multiplexer 410 may be an application specific integrated circuit (ASIC), and the register controller 430 may be hard-wired to a predetermined number of register set 510. Alternatively, the register controller 430 may be implemented by firmware, with the number of the register sets 510 based on memory size. Additionally, a data length register and a word length register are provided to define row and column sizes in the programmable table 402. The data structure of the programmable table 402 is described in FIG. 6.

FIG. 6 shows an embodiment of the programmable table 402 established by one of the register sets 510. Each row contains two columns, N bytes DATA and M bytes TAG The optional data length register defines the size N, and the optional word length register defines the size N+M. The two registers are optional because the lengths are typically predefined by the spec. A DATA column stores the extracted field information from a PES parser 420, and a TAG is a unique identification number associating the DATA with its origin PES packet 120. Alternatively, the TAG may be a pointer allocating the starting address of the memory 220 of the corresponding access unit 130. Thus, by the TAG, relationships between various columns and the access units 130 can be maintained. As described, the DATA type can be any field in a PES header 106 or a header within ES 112, the total fields in the PES header 106 or the header within ES 112, a start code indicator, or a picture type, according to the buffer type register.

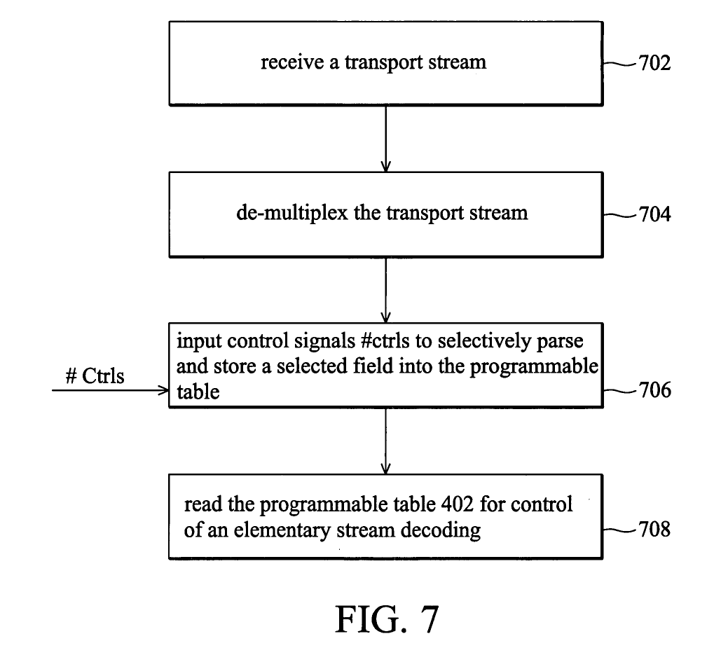

FIG. 7 is a flowchart of the de-multiplexing method according to the invention. In step 702, a transport stream is received. In step 704, the transport stream is de-multiplexed to a plurality of PES packets 120 and an elementary stream with compressed data 130 corresponding to a specific program, and the PES headers 106 and headers within ES 112 therein are simultaneously parsed by the PES/ES parser 420 in the de-multiplexer 410. In step 706, control signals #ctrls are input to store a selected field into the programmable table 402, established accordingly in the memory 220. The corresponding access units 130 composed from the PES payloads 108 are also stored in an elementary stream buffer 404. In step 708, the system controller 240 reads information from the programmable table 402 for control of an elementary stream decoding, while the decoder 250 reads the access units 130 from the elementary stream buffer 404 to perform the elementary stream decoding controlled by the system controller 240. Post-parsing in the system controller 240 is not required because essential information is already provided in step 706, thus the computational power of the system controller 240 is conserved, and burdensome memory access is reduced. As an example, the control signals #ctrls are typically generated by the system controller 240, and the memory 220 may be a dynamic random access memory (DRAM). The system controller 240 may be a regular instruction set computer (RISC) processor, and the decoder 250 may be an alternative of a video decoder and an audio decoder.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A DTV decoding system for de-multiplexing a transport stream comprising a plurality of packetized elementary stream (PES) packets, wherein:
each PES packet comprises a header and a payload; and
the header comprises a plurality of fields recording information associated with the payload;
the DTV decoding system comprising:
a de-multiplexer, receiving the transport stream and decoding the PES packets therein, and selectively extracting corresponding fields and payloads in the PES packets based on a control signal;
a memory, coupled to the de-multiplexer, comprising a plurality of programmable tables each storing a field of a specific type, and an elementary stream buffer storing access units extracted from the payloads;
a system controller, coupled to the memory, reading the fields in the programmable tables to control an elementary stream decoding; and
a decoder, coupled to the memory, reading the access units in the elementary stream buffer to perform the elementary stream decoding; wherein:
the control signal delivers a request for a specific field; and
a programmable table is accordingly established upon receipt of the control signal and the de-multiplexer extracts the specific field thereto.

2. The DTV decoding system as claimed in claim 1, wherein the de-multiplexer comprises:
a register controller, performing field selection and programmable table management based on the control signal; and
a PES parser, decoding the PES packets, and synchronously extracting the selected fields and the access units to the programmable tables and the elementary stream buffer.

3. The DTV decoding system as claimed in claim 2, wherein the register controller comprises a plurality of register sets configuring corresponding programmable tables based on the control signal, and each register set comprises:
a start address register, allocating the starting address of the corresponding programmable table; and
a buffer type register, defining the field the corresponding programmable table represents.

4. The DTV decoding system as claimed in claim 3, wherein each register set further comprises a buffer valid register, defining whether the current register set is enabled to establish a programmable table in the memory.

5. The DTV decoding system as claimed in claim 3, wherein:
each programmable table comprises a plurality of rows each comprising:
a data column, storing information of a selected field extracted from the PES parser; and
a tag column, storing an unique TAG associated with each access unit; and
each register set further comprises:
a word length register, defining the row size; and
a data length register, defining the data column size.

6. The DTV decoding system as claimed in claim 1, wherein:
the memory is a dynamic random access memory (DRAM);
the system controller is a regular instruction set computer (RISC) processor;
the decoder is an alternative of a video decoder and an audio decoder; and
the control signal is delivered by the system controller.

7. A de-multiplexing method for a DTV decoding system, comprising:
receiving a transport stream comprising a plurality of PES packets, wherein:
each PES packet comprises a header and a payload; and
the header comprises a plurality of fields recording information associated with the payload;
selectively extracting at least one field from the transport stream to a programmable table;
extracting the payloads from the PES packets, and reorganizing access units from the payloads for storage in an elementary stream buffer;
reading the fields in the programmable table to control an elementary stream decoding; and
reading the access units in the elementary stream buffer for the elementary stream decoding; wherein:
the field to extract is selected by a control signal, and the programmable table is accordingly established when the field is selected.

8. The de-multiplexing method as claimed in claim 7, wherein the selective extraction comprises:
providing a plurality of register sets each comprising:
a start address register, allocating the starting address of the corresponding programmable table; and
a buffer type register, defining the field type the corresponding programmable table represents;
the control signal configuring one of the register sets;
the configured register set establishing the programmable table for storage of the selected field; and
extracting the selected field to the programmable table.

9. The de-multiplexing method as claimed in claim 8, wherein each register set further comprises a buffer valid register defining whether the current register set is enabled to allocate a programmable table.

10. The de-multiplexing method as claimed in claim 8, wherein:
each programmable table comprises a plurality of rows each comprising:
a data column, storing a field of the corresponding type extracted from the PES parser; and
a tag column, storing an unique TAG associated with each access unit; and
each register set further comprises:
a word length register, defining the row size; and
a data length register, defining the data column size.

11. The de-multiplexing method as claimed in claim 7, wherein the programmable tables and the elementary stream buffer are implemented in a memory.

12. A data stream de-multiplexing system for de-multiplexing a data stream comprising a plurality of data units, wherein:
each data unit comprises at least one header with remaining data as payloads; and
the header comprises a plurality of fields recording information associated with the payloads;
the data stream de-multiplexing system comprising:
a memory, comprising a plurality of programmable tables;
a system controller, comprising a plurality of registers to specify the desired fields in the header, and program the programmable tables;
a de-multiplexer, receiving the data stream, selectively extracting corresponding fields according to the register setting, and storing the extracted field in the programmable table.

13. The data stream de-multiplexing system as claimed in claim 12, wherein:
the memory is a dynamic random access memory (DRAM);
the system controller is a regular instruction set computer (RISC) processor; and
the de-multiplexer is an alternative of a video decoder and an audio decoder.

14. A de-multiplexing method for a data stream de-multiplexing system de-multiplexing a data stream comprising a plurality of data units, wherein:
each data unit comprises at least one header with remaining data as payloads; and
the header comprises a plurality of fields recording information associated with the payloads;
the data stream de-multiplexing system comprising:
a memory, comprising a plurality of programmable tables;
a system controller, comprising a plurality of registers to specify the desired fields in the header, and program the programmable tables;
a de-multiplexer, receiving the data stream, selectively extracting corresponding fields according to the register setting, and storing the extracted field in the programmable table;
the de-multiplexing method comprising:
configuring the programmable tables according to the register settings;
extracting selected field from the header to a corresponding programmable table; and
performing the data stream decoding based on the data stored in programmable table.
